(19) United States
(12) Patent Application Publication
(10) Pub. No.: US 2015/0235786 A1
(43) Pub. Date: Aug. 20, 2015

(54) PUSH BUTTON SWITCH

(71) Applicants: Masaki Sugihara, Kyoto (JP); Eiji Yuasa, Tokyo (JP)

(72) Inventors: Masaki Sugihara, Kyoto (JP); Eiji Yuasa, Tokyo (JP)

(73) Assignees: MITSUBISHI ELECTRIC CORPORATION, Tokyo (JP); OMRON CORPORATION, Kyoto-shi, Kyoto (JP)

(21) Appl. No.: 14/401,786

(22) PCT Filed: May 17, 2012
(86) PCT No.: PCT/JP2012/062602

§ 371 Date: Apr. 9, 2015

(51) Int. Cl. H01H 13/02; H01H 13/04; H01H 13/10; H01H 13/52; H01H 13/14

(52) U.S. Cl. CPC H01H 13/023; H01H 13/52; H01H 13/14; H01H 13/10; H01H 13/04; H01H 2231/03

(57) ABSTRACT

A push button switch has a box-shaped base, a first operating lever and a second operating lever, wherein each of the first operating lever and the second operating lever has a substantially U shape in a plan view, wherein the first operating lever and the second operating lever are arranged on the box-shaped base pivotally about middle parts of both arms as fulcra, and wherein the first operating lever and the second operating lever connect the tips of the both arms mutually pivotally and support the tips of the both arms in a vertically movable manner, an operating cover that has a planar shape covering the connected first and second operating levers and forms an operating hole at nearly the center thereof, and a plunger, wherein the plunger has a sectional shape capable of fitting into the operating hole of the operating cover.

### BACKGROUND

1. Field

The present invention relates to a push button switch for use in elevators or the like, and in particular, to a self-illuminated push button switch.

2. Related Art

There is a push button switch having a parallelly operating link mechanism so as to allow an operating button to be stably operated without inclination as a self-illuminated push button switch (refer to Patent Literature 1).

### CITATION LIST

### Patent Literature

Patent Literature 1: Japanese Patent Application Laid-open No. 2008-171794

### SUMMARY

However, as illustrated in FIG. 4 of Patent Literature 1, for example, the above push button switch arranges a leaf spring for operating a switch body arranged at nearly the center of a lever link mechanism immediately above the switch body. This requires light sources to be arranged near the switch body and the leaf spring and four light sources are required to be arranged to achieve desired luminous intensity, thereby being high in parts count and assembly man-hours.

One or more embodiments of the present invention provides a push button switch that can be operated stably without inclining an operating button, has a low parts count, and has high illumination performance.

A push button switch according to one or more embodiments of the present invention includes a box-shaped base; first and second operating levers that have a nearly U shape in a plan view, are arranged on the box-shaped base pivotally about middle parts of both arms, and connect the tips of the both arms mutually pivotally and support the tips of the both arms in a vertically movable manner; an operating cover that has a planar shape covering the connected first and second operating levers and forms an operating hole at nearly the center thereof; a plunger that has a sectional shape capable of fitting into the operating hole of the operating cover, is capable of pressing down the opening edge of the operating hole, and is formed of a transparent material; a switch body that is arranged in the middle area of the arms of the levers on the upper face of the box-shaped base and is driven by the plunger through the operating cover; and a light source positioned immediately below the plunger.

One or more embodiments of the present invention achieves stable operation without inclination of the plunger by a parallelly operating link mechanism that operates by pressing down the pair of operating levers through the operating cover.

The light source is positioned immediately below the plunger formed of the transparent material and has high illumination performance, thereby achieving a push button switch that can illuminate with a small number of light sources and is low in parts count and assembly man-hours.

In one or more embodiments of the present invention, a cushioning material may be arranged between the switch body and the operating cover.

One or more embodiments of the present invention achieves a push button switch that causes the cushioning material to absorb parts error and assembly errors and is free from rattling.

In one or more embodiments of the present invention, the operating cover may be opaque.

One or more embodiments of the present invention achieves a push button switch with reduced light leakage from the light source and further improved illumination performance.

In one or more embodiments of the present invention, the light source mounted on the upper face of a printed board whose one end is inserted into an insertion hole formed in the base from below and that is assembled to the lower face of the base may be exposed out of a through hole formed in the base so as to be positioned immediately below the plunger.

One or more embodiments of present invention may achieve a push button switch that can effectively utilize the thickness dimension of the bottom face of the base and is further thinner.

### BRIEF DESCRIPTION OF DRAWINGS

FIGS. 1A, 1B are perspective views illustrating a push button switch according to one or more embodiments of the present invention.

FIGS. 2A, 2B, 2C are a plan view, an elevational view of the push button switch illustrated in FIG. 1, and a C-C line plan sectional view of FIG. 2B, respectively.

FIG. 3 is an exploded perspective view of the perspective view illustrated in FIG. 1A.

FIG. 4 is an exploded perspective view of the perspective view illustrated in FIG. 1B.

FIGS. 5A, 5B, 5C, 5D are a plan view of a base illustrated in FIG. 2A, a B-B line sectional view, a C-C line sectional view, and a D-D line sectional view of FIG. 5A, respectively.

FIGS. 6A, 6B, 6C are an exploded perspective view, an exploded plan view of first and second operating levers illustrated in FIG. 1A, and a C-C line sectional view of FIG. 6B, respectively.

FIGS. 7A, 7B, 7C are a plan view of the push button switch illustrated in FIG. 1A before operation, a B-B line sectional view, and a C-C line sectional view of FIG. 7A, respectively.

FIGS. 8A, 8B, 8C are a plan view of the push button switch illustrated in FIG. 1A after operation, a B-B line sectional view, and a C-C line sectional view of FIG. 8A, respectively.

FIGS. 9A, 9B are partial sectional elevational views illustrating the push button switch according to one or more embodiments of the present invention before and after operation, respectively.

FIG. 10A is a schematic diagram illustrating the operating principle, FIG. 10B is a schematic diagram illustrating the operating principle of the push button switch according to one or more embodiments of the present invention, and FIG. 100 is a schematic diagram illustrating the operating principle of a push button switch according to a comparative example.

### DETAILED DESCRIPTION

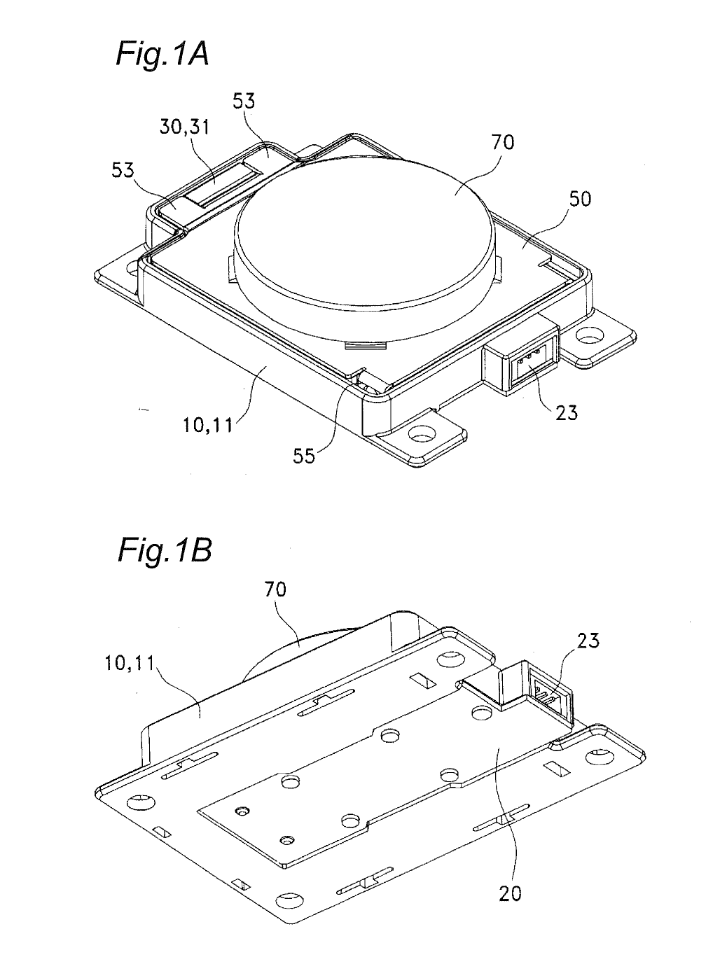

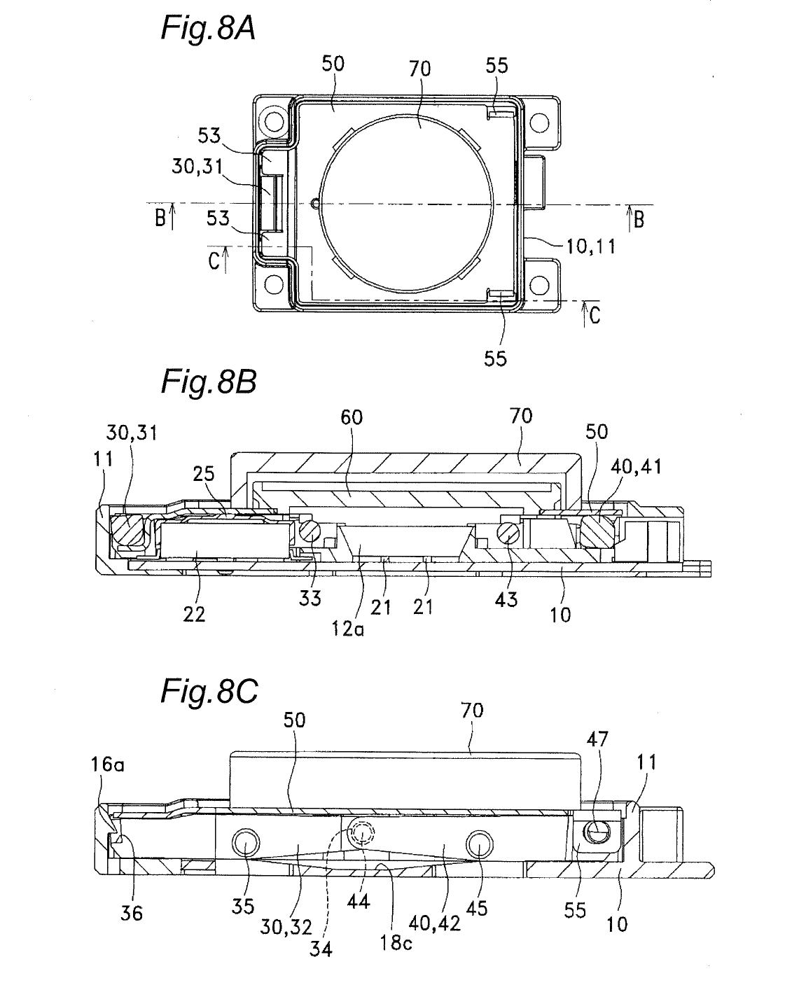

Embodiments of the present invention will be described with reference to the attached drawings of FIG. 1 to FIG. 10. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

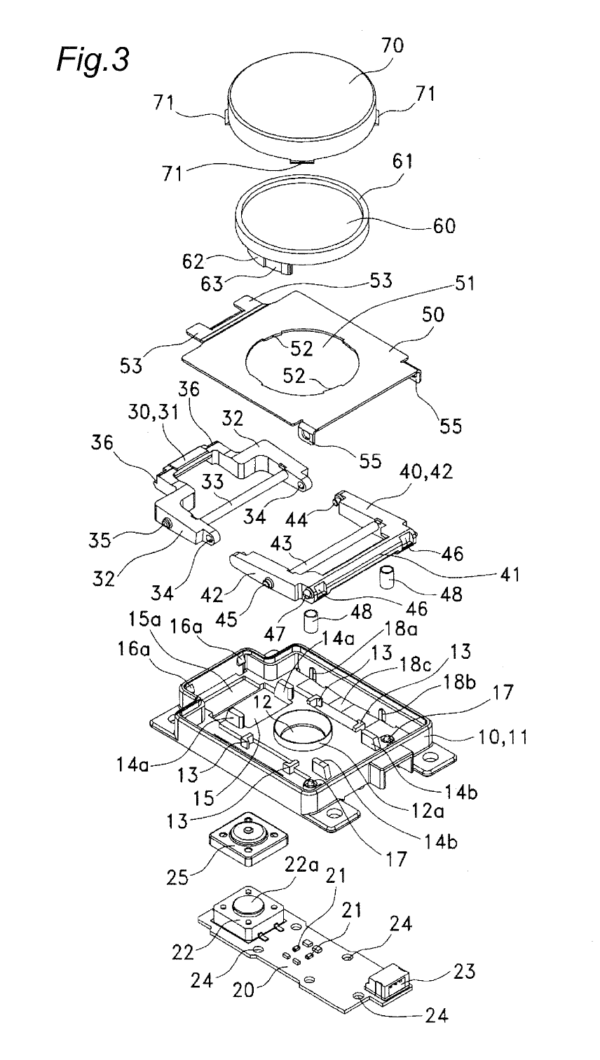

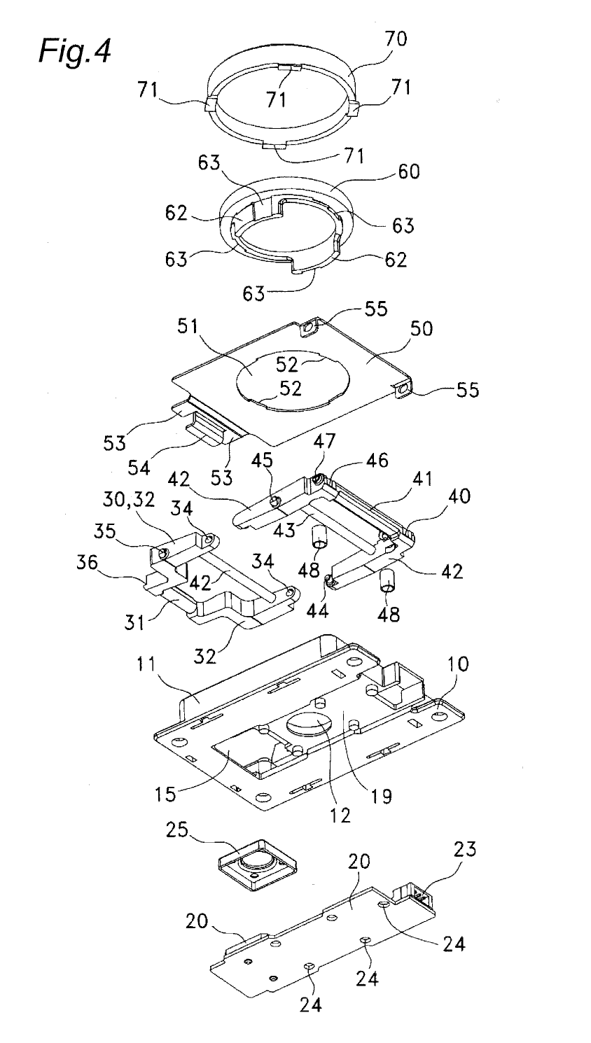

As illustrated in FIG. 3 and FIG. 4, the push button switch according to one or more embodiments of the present invention includes a nearly rectangular base 10 into which a printed board 20 is incorporated, first and second operating levers 30, 40, an operating cover 50, a plunger 60, and an operating button 70.

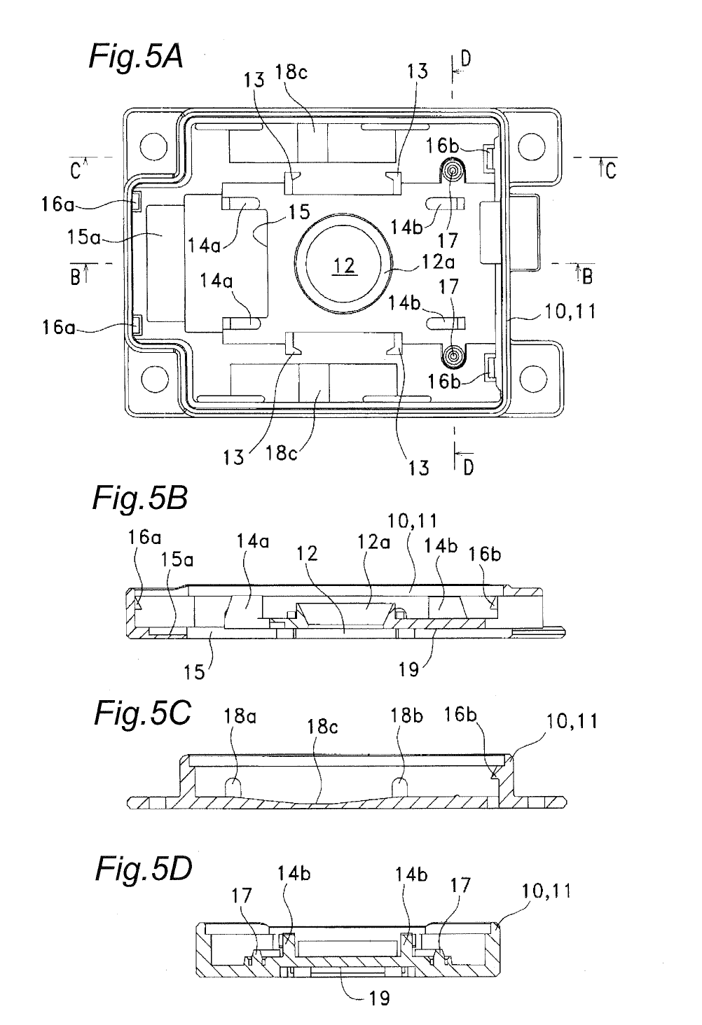

As illustrated in FIG. 5, the base 10 protrudes a surrounding wall 11 on the upper face thereof and protrudes a cone-shaped circular protrusion 12a on the opening edge of the upper face of a through hole 12 formed at the central part of the upper face thereof.

The base 10 forms positioning protrusions 13 around the circular protrusion 12a on the upper face thereof and protrudes positioning ribs 14a, 14b near the positioning protrusions 13. The base 10 forms an insertion hole 15 between the positioning ribs 14a, 14a and forms a fitting step 15a so as to communicate with the insertion hole 15. The base 10 protrudes insertion protrusions 17 for inserting coil springs 48 described below at one-side corners on the upper face thereof.

The surrounding wall 11 forms two pairs of shaft receiving grooves 18a, 18b on the facing inner side walls thereof so that each pair of ones are on the same line and protrudes two pairs of retaining claws 16a, 16b on the residual facing inner side walls so that each pair of ones are arranged side by side.

The base 10 forms a recess 19 (FIG. 4) into which a printed board 20 described below is fitted so as to communicate with the insertion hole 15 on the lower face thereof.

As illustrated in FIG. 3, the printed board 20 has a planar shape that can be fitted into the recess 19 formed on the bottom face of the base 10. The printed board 20 mounts a pair of LEDs 21, 21 along the longitudinal direction at the central part of the upper face thereof, and mounts a tactile switch 22 at one end of the upper face thereof, and mounts a connector 23 at the other end of the upper face thereof. A rubber cushioning material 25 is fitted onto the upper face of the tactile switch 22 in order to absorb assembly errors and protect it from external impacts.

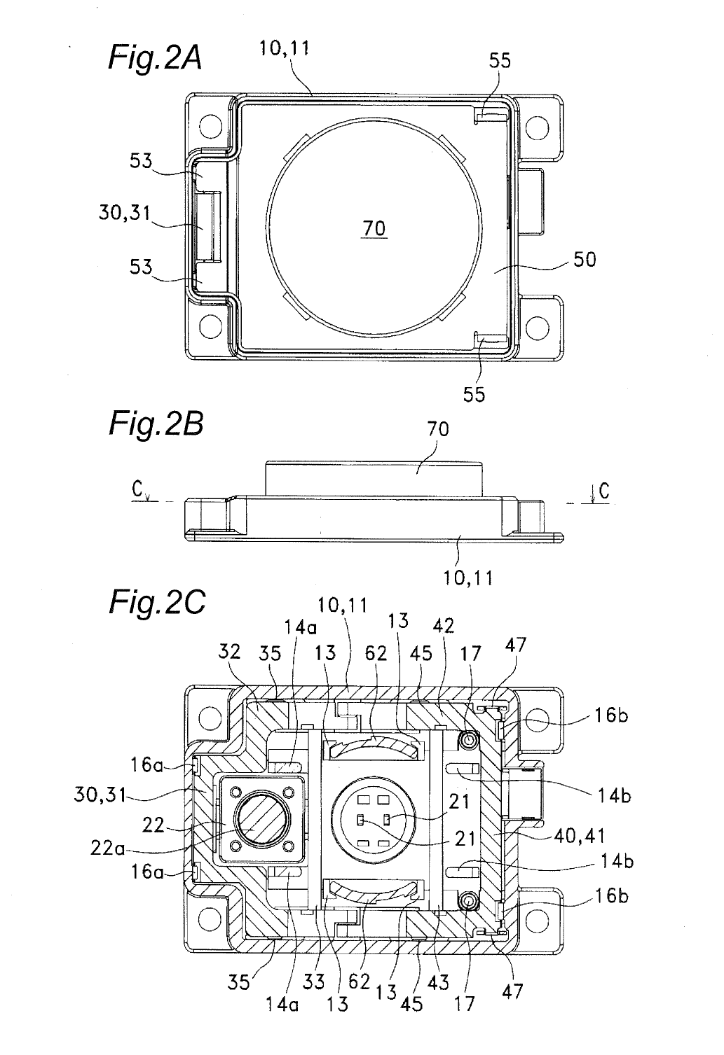

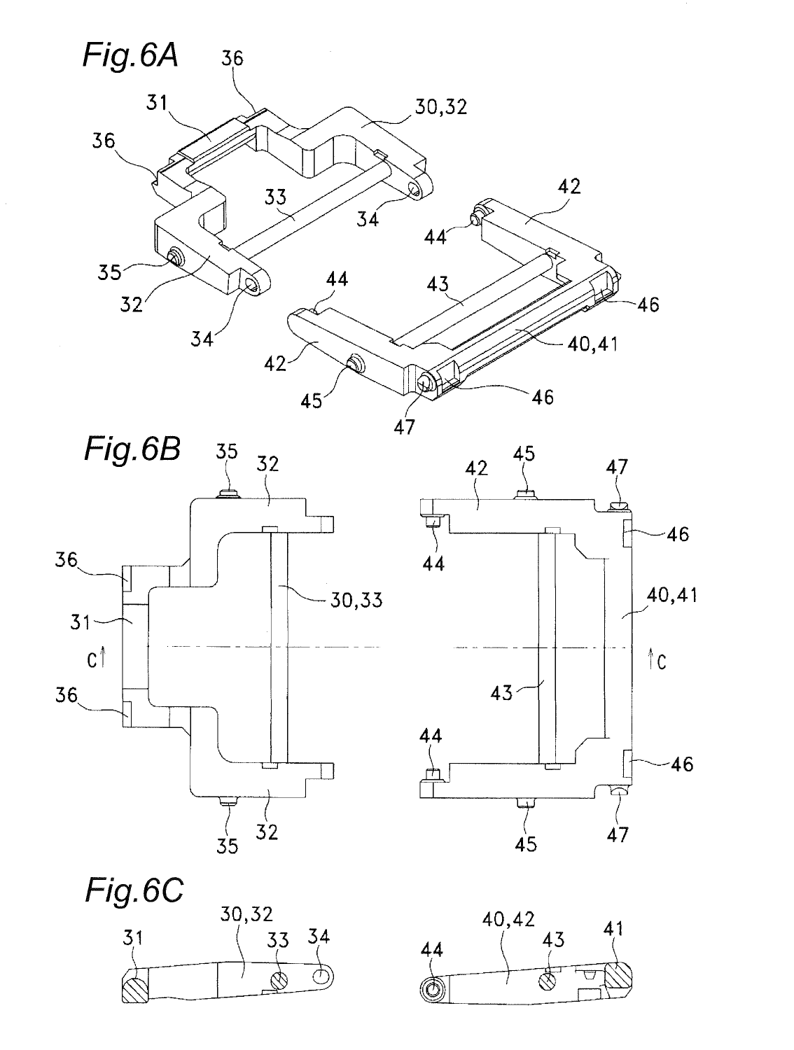

As illustrated in FIG. 2 and FIG. 6, the first and second operating levers 30, 40 form a frame shape along the inner circumferential face of the surrounding wall 11 of the base 10.

The first operating lever 30 is reinforced by connecting arms 32, 32 extended from both ends of a connecting part 31 with a connecting rod 33 and forms shaft receiving holes 34 at their tips. The first operating lever 30 forms pivoting shafts 35 on the outer side faces of the arms 32 on the same axis and forms retaining notches 36 at corners of the connecting part 31.

The second operating lever 40 is reinforced by connecting arms 42, 42 extended from both ends of a connecting part 41 with a connecting rod. 43 and protrudes connecting shafts 44 at the tips of the inner side faces of the arms 42 on the same axis. The second operating lever 40 forms pivoting shafts 45 on the outer side faces of the arms 42 on the same axis. The connecting part 41 forms retaining notches 46 at both ends of the outer face thereof and protrudes engagement shafts 47 on both end faces thereof on the same axis.

The operating cover 50 has a planar shape that can be housed within the surrounding wall 11 of the base 10, forms an operating hole 51 at the central part thereof, and forms locking protrusions 52 on the inner periphery of the operating hole 51 at a certain pitch. The operating cover 50 forms a support bent part 54 formed by bending downward between a pair of support tongue pieces 53, 53 cut out of the center of one side edge thereof. The operating cover 50 bends downward engagement tongue pieces 55 cut out of the corners positioned at the other side thereof.

The plunger 60 has a disc shape that can be mounted on the opening edge of the operating hole 51 of the operating cover 50 and is formed of a transparent resin material that can diffuse the light of the LEDs 21. The plunger 60 protrudes a circular rib 61 on the periphery of the upper face thereof and protrudes legs 62, 62 at facing positions on the opening edge of the lower face thereof.

The plunger 60 forms locking recesses 63 to be locked to the locking protrusions 52 of the cover 50 to be integrated.

The operating button 70 has a planar shape that can cover the plunger 60, is formed of a transparent material in a shape having a nearly U-shaped cross section, and forms retaining claws 71 on the periphery at a certain pitch.

Next, a method for assembling the above components will be described. One or more embodiments of the present invention is assembled so that the operating button 70 protrudes through an operating hole formed in a panel (not illustrated) in an operable manner.

First, one end of the printed board 20 mounting the LEDs 21, the tactile switch 22, and the connector 23 is inserted into the insertion hole 15 of the base 10 from below, is fitted into the fitting step 15a formed on the upper face of the base 10, and is then crimped within the recess 19 of the base 10 through crimping holes 24. The tactile switch 22 is then covered with the cushioning material 25.

The return coil springs 48 are inserted into the insertion protrusions 17 of the base 10. The connecting shafts 44 of the second operating lever 40 engage with the shaft receiving holes 34 of the first operating lever 30 to be pivotally assembled. The first and second operating levers 30, 40 are assembled to the upper face of the base 10. In this situation, as illustrated in FIG. 2, the connecting part 31 of the first operating lever 30 is arranged between the retaining claws 16a and the positioning ribs 14a, whereas the connecting rod 33 is arranged between the positioning ribs 14a and the positioning protrusions 13. The pivoting shafts 35 of the first operating lever 30 engage with the shaft receiving grooves 18a formed on the inner circumferential face of the surrounding wall 11 of the base 10 to be pivotally supported. The tactile switch 22 is arranged between the shaft receiving holes 34 and the connecting part 31 of the first operating lever 30.

Similarly, the connecting part 41 of the second operating lever 40 is arranged between the retaining claws 16b and the positioning ribs 14b, whereas the connecting rod 43 is arranged between the positioning ribs 14b and the positioning protrusions 13. The pivoting shafts 45 of the second operating lever 40 engage with the shaft receiving grooves 18b formed on the inner circumferential face of the surrounding wall 11 of the base 10 to be pivotally supported.

Thus, one or more embodiments of the present invention achieves a push button switch that is resistant to the occurrence of rattling and malfunction in the first and second operating levers 30, 40 even when vibrations are applied.

The LEDs 21 mounted on the printed board 20 are exposed out of the through hole 12 of the base 10 with no shield thereabove, thereby causing the advantage of being capable of illuminating with a small number of LEDs 21 having high illumination performance.

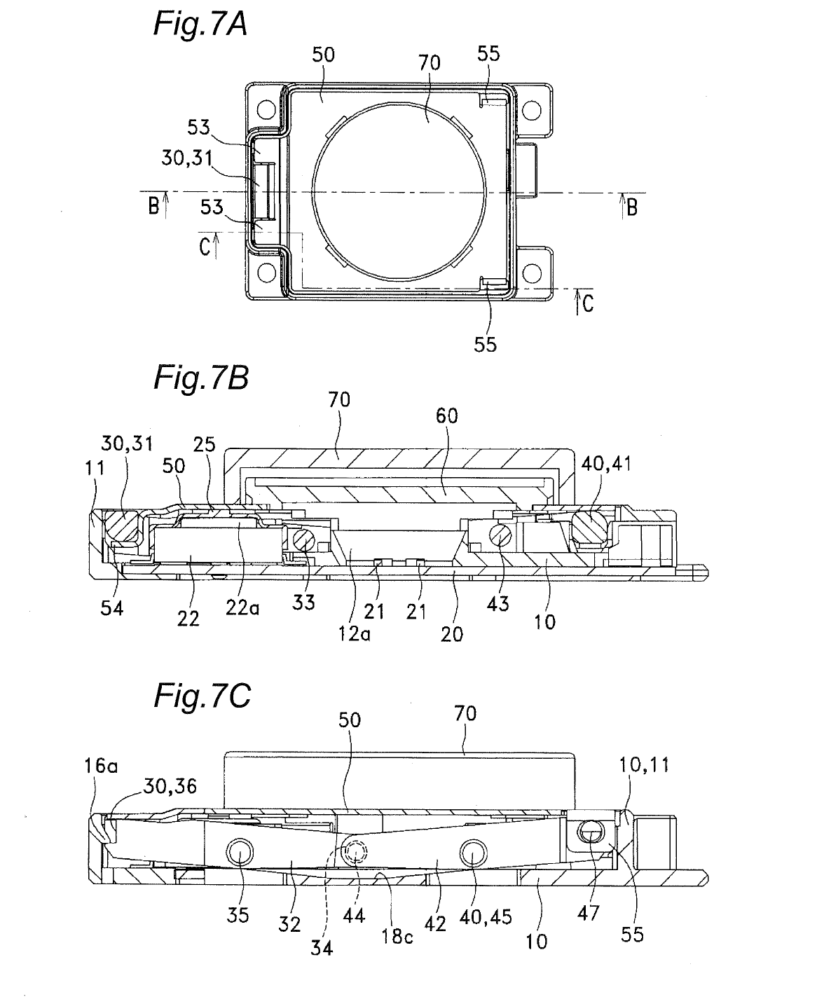

The connecting part 31 of the first operating lever 30 is held between the support tongue pieces 53 of the operating cover 50 with the plunger 60 assembled in advance and the support bent part 54. The engagement tongue pieces 55 of the operating cover 50 engage with the engagement shafts 47 of the second operating lever 40, thereby integrating the operating cover 50 into the first and second operating levers 30, 40. Owing to this, the spring force of the coil springs 48 and the pushing-up force of the tactile switch 22 bias the connecting part 31 of the first operating lever 30 and the connecting part 41 of the second operating lever 40 upward, thereby positioning the tips of the arms 32, 42 of the first and second operating levers 30, 40 lowermost (FIG. 7).

The periphery on the lower face of the plunger 60 is mounted on the opening edge of the operating hole 51, whereas as illustrated in FIG. 2, the legs 62 of the plunger 60 are positionally restricted by the positioning protrusions 13 of the base 10. However, before operation, the legs 62 of the plunger 60 are suspended above the upper face of the base 10.

The operating button 70 is assembled to the plunger 60 and is positioned on the operating cover 50. It is noted that, with one or more embodiments of the present invention, a panel (not illustrated) covers the push button switch and the operating button 70 protrudes through the operating hole of the panel in an operable manner. It is understood that the operating button may be a differently shaped operating button as needed.

Next, the operation of the push button switch will be described with reference to FIG. 7 to FIG. 10.

As illustrated in FIG. 7, the operating cover 50 before operation is biased upward through the pushing-up force of the tactile switch 22 and the spring force of the coil springs 48. Owing to this, the tips of the arms 32, 42 of the first and second operating levers 30, 40 are positioned lowermost. Because recesses 18c are formed at the corners on the upper face of the base 10, the tips of the arms 32, 42 of the first and second operating levers 30, 40 are not in contact therewith. The retaining notches 36, 46 of the first and second operating levers 30, 40 engage with the retaining claws 16a, 16b of the base 10, thereby preventing falling.

When the operating button 70 is pressed down, the operating cover 50 is pressed down against the pushing-up force of the tactile switch 22 and the spring force of the coil springs 48, thereby pivoting the first and second operating levers 30, 40 about the pivoting shafts 35 and the pivoting shafts 45 as fulcra, respectively. This causes the tips of the arms 32, 42 of the first and second operating levers 30, 40 to be lifted upward and causes the operating cover 50 to press down a push button part 22a of the tactile switch 22 through the cushioning material 25. This causes the LEDs 21 to light up based on the switching operation of the tactile switch 22 or instructions from an external circuit when power is externally supplied to the components mounted on the printed board 20 through the connector 23.

When the pressing-down force on the operating button 70 is then released, the pushing-up force of the tactile switch 22 and the spring force of the coil springs 48 push up the connecting part 31 of the first operating lever 30 and the connecting part 41 of the second operating lever 40, which return to their original positions through operation opposite to the above.

With one or more embodiments of the present invention, the tactile switch 22 can be turned on and off without largely inclining the operating button 70 by the parallelly operating link mechanism including the operating levers 30, 40 even when an operation position on the operating button 70 is deviated from the center.

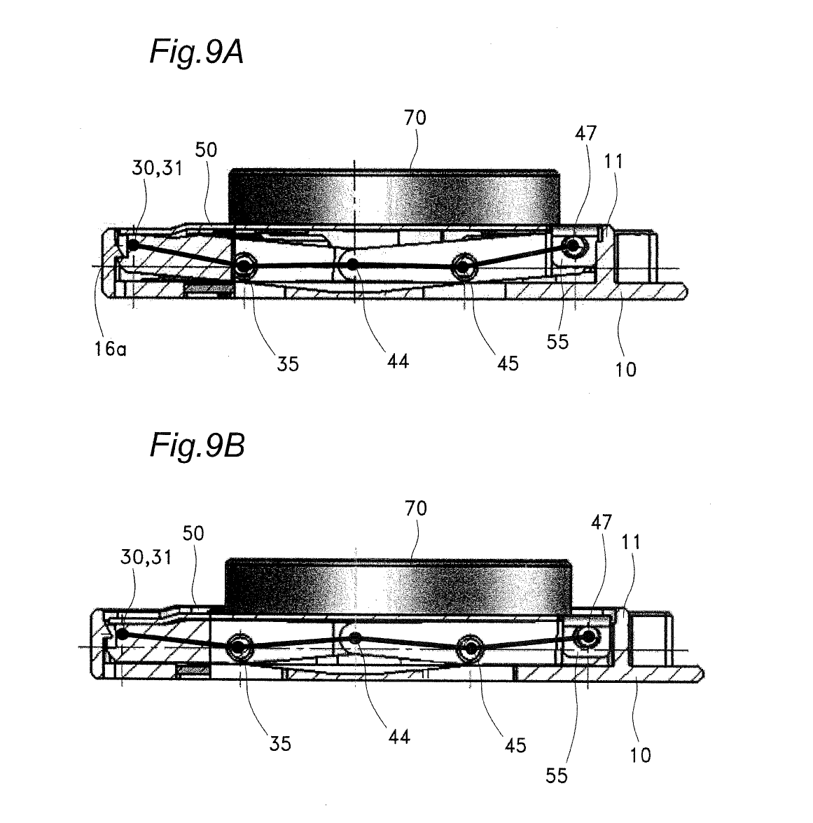

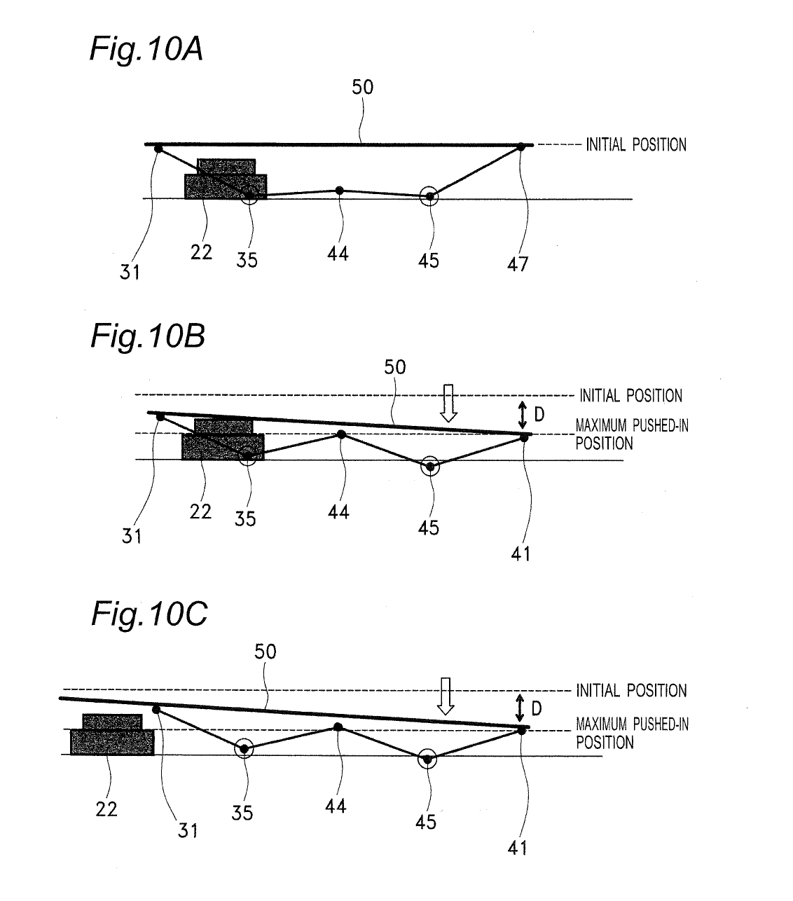

The one or more embodiments of the present invention, for which partial sectional views before and after pressing down are illustrated in FIGS. 9A, 9B, is described by schematically illustrating in FIGS. 10A, 10B for the convenience of description.

Specifically, the tactile switch 22 is arranged between the axis of the connecting part 31 of the first operating lever 30 and the axis of the shaft receiving holes 34 formed at the tips of the arms 32. Owing to this, even when a maximum pushing-in amount D is small, the tactile switch 22 can be operated.

When the tactile switch 22 is arranged outside the axis of the connecting part 31 of the first operating lever 30 as a comparative example illustrated in FIG. 100, the tactile switch 22 cannot be operated even when the maximum pushing-in amount D is the same as that of one or more embodiments of the present invention. In order for the comparative example to be operated, the maximum pushing-in amount D is required to be further increased.

Thus, one or more embodiments of the present invention has the advantage of being capable of achieving a push button switch that can operate the tactile switch 22 with a relatively small amount of pushing-in amount and is thinner than the comparative example.

A push button switch according to one or more embodiments of the present invention appropriately arranges the switch body between the connecting parts and the tips of the arms of the first and second operating levers so as to be operable through the operating cover and that the position of the switch body can be finely adjusted as needed.

A push button switch according to one or more embodiments of the present invention can be used in other uses without being limited to elevators.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

10 Base
11 Surrounding wall
12 Through hole
12a Circular protrusion
13 Positioning protrusion
14a, 14b Positioning rib
16a, 16b Retaining claw
17 Insertion protrusion
18a, 18b Shaft receiving groove
20 Printed board
21 LED
22 Tactile switch
23 Connector
24 Crimping hole
25 Cushioning material
30 First operating lever
31 Connecting part
32 Arm
33 Connecting rod
34 Shaft receiving hole
35 Pivoting shaft
36 Retaining notch
40 Second operating lever
41 Connecting part
42 Arm
43 Connecting rod
44 Connecting shaft
45 Pivoting shaft
46 Retaining notch
47 Engagement shaft
50 Operating cover
51 Operating hole
52 Locking protrusion
53 Support tongue piece
54 Support bent part
55 Engagement tongue piece
60 Plunger
62 Leg
63 Locking recess
70 Operating button

1.-4. (canceled)

5. A push button switch, comprising:
a box-shaped base;
a first operating lever and a second operating lever,
wherein each of the first operating lever and the second operating lever has a substantially U shape in a plan view,
wherein the first operating lever and the second operating lever are arranged on the box-shaped base pivotally about middle parts of both arms as fulcra, and
wherein the first operating lever and the second operating lever connect the tips of the both arms mutually pivotally and support the tips of the both arms in a vertically movable manner;
an operating cover that has a planar shape covering the connected first and second operating levers and forms an operating hole at nearly the center thereof;
a plunger,
wherein the plunger has a sectional shape capable of fitting into the operating hole of the operating cover,
wherein the plunger is capable of pressing down the opening edge of the operating hole, and
wherein the plunger is formed of a transparent material;
a switch body,
wherein the switch body is arranged in the middle area of the arms of the levers on the upper face of the box-shaped base, and
wherein the switch body is driven by the plunger through the operating cover; and
a light source positioned immediately below the plunger.

6. The push button switch according to claim 5, wherein a cushioning material is arranged between the switch body and the operating cover.

7. The push button switch according to claim 5, wherein the operating cover is opaque.

8. The push button switch according to claim 6, wherein the operating cover is opaque.

9. The push button switch according to claim 5, wherein the light source mounted on the upper face of a printed board whose one end is inserted into an insertion hole formed in the base from below and that is assembled to the lower face of the base is exposed out of a through hole formed in the base so as to be positioned immediately below the plunger.

10. The push button switch according to claim 6, wherein the light source mounted on the upper face of a printed board whose one end is inserted into an insertion hole formed in the base from below and that is assembled to the lower face of the base is exposed out of a through hole formed in the base so as to be positioned immediately below the plunger.

11. The push button switch according to claim 7, wherein the light source mounted on the upper face of a printed board whose one end is inserted into an insertion hole formed in the base from below and that is assembled to the lower face of the base is exposed out of a through hole formed in the base so as to be positioned immediately below the plunger.

12. The push button switch according to claim 8, wherein the light source mounted on the upper face of a printed board whose one end is inserted into an insertion hole formed in the base from below and that is assembled to the lower face of the base is exposed out of a through hole formed in the base so as to be positioned immediately below the plunger.
